(19) United States
(12) Patent Application Publication
(10) Pub. No.: US 2025/0350126 A1
(43) Pub. Date: Nov. 13, 2025

(54) Mid-term coordinated dispatch method for hydro-wind-solar hybrid systems incorporating multi-regional daily load profiles

(71) Applicant: DALIAN UNIVERSITY OF TECHNOLOGY, Dalian (CN)

(72) Inventors: Jianjian SHEN, Dalian (CN); Yue WANG, Dalian (CN); Junping YAN, Dalian (CN); Xihai GUO, Dalian (CN); Songlin GE, Dalian (CN); Chuntian CHENG, Dalian (CN)

(21) Appl. No.: 19/268,157

(22) Filed: Jul. 14, 2025

Related U.S. Application Data
(63) Continuation of application No. PCT/CN2024/111321, filed on Aug. 12, 2024.

(51) Int. Cl. H02J 3/38; G05B 13/04

(52) U.S. Cl. CPC H02J 3/381; G05B 13/047; H02J 2300/24; H02J 2300/28

(57) ABSTRACT

This invention advances power grid operational planning by introducing a mid-term scheduling framework for integrated hydro-wind-solar systems that accounts for heterogeneous daily load profiles across multiple receiving-end power grids. The proposed approach utilizes an adaptive variable-step search algorithm to segment loads into peak, flat, and valley intervals. By synthesizing five key metrics, including mean daily load, daily load factor, peak-valley differential ratio, load rates during peak/valley periods, and timing of peak/valley occurrences, the method accurately captures region-specific load patterns and peak-shaving demands. This enables a refined reconstruction of load profiles of receiving-end power grids. A nested multi-temporal scheduling model that couples medium- and short-term horizons to simultaneously maximize total energy production and minimize transmission imbalances among power grids. The model is addressed by using the mixed-integer linear programming (MILP) to obtain medium- and short-term generation schedules and power transmission schedules.

### CROSS REFERENCE TO RELATED APPLICATIONS

This application is a Continuation of co-pending International Application No. PCT/CN2024/111321 filed on Aug. 12, 2024, for which priority is claimed under 35 U.S.C. § 120, the entire contents of all of which are hereby incorporated by reference.

### TECHNICAL FIELD

The present invention relates to power system operations and a mid-term coordinated dispatch method for hydro-wind-solar hybrid systems incorporating multi-regional daily load profiles.

### BACKGROUND

The reverse distribution of energy resources and load demands in China necessitates large-scale inter-provincial/inter-regional power transmission as the key solution for integrating hydro-wind-solar clean energy from southwestern/northwestern/northern bases. However, significant challenges emerge due to the following characteristics. First, substantial demand variations among receiving-end provinces (municipalities) with divergent load characteristics. Second, stringent requirements for peak-shaving capacity in inter-regional high voltage direct current (HVDC) power transmission. Third, it is very important to accurately describe load characteristics of multiple receiving-end power grids in transmission scheduling. Furthermore, the rapid expansion of wind/solar installed capacity (particularly in renewable energy integrated zone) intensifies operation complexities through frequent multi-day extreme operating scenarios. These challenges constitute major operational bottlenecks for basin-wide renewable energy integrated zone and high-renewable penetration power grids, requiring urgent solutions in practical dispatch operations.

To accurately characterize load profiles of power grids, conventional indices include the daily load factor reflecting diurnal load variations, daily peak-to-valley difference rate indicating grid peak-shaving capability, daily maximum load utilization hours measuring temporal efficiency, peak/valley occurrence times identifying critical load nodes (Wan Q, Yu Y. Power load pattern recognition algorithm based on characteristic index dimension reduction and improved entropy weight method[J]. Energy Reports, 2020, 6:797-806.), and peak/flat/valley period load rates quantifying segmented load dynamics (Si C, et al. Electric load clustering in smart grid: Methodologies, applications, and future trends[J]. Journal of Modern Power Systems and Clean Energy, 2021, 9(2): 237-252.). While these indices capture global load characteristics, they lack refined descriptions of localized load fluctuations and sequential flexibility requirements. To address this, load reconstruction methods have been developed, involving scheduling-period segmentation of load curves (Yang H, et al. Optimal modification of peak-valley period under multiple time-of-use schemes based on dynamic load point method considering reliability[J]. IEEE Transactions on Power Systems, 2021, 37(5): 3889-3901.) followed by equivalent load curve formulation based on sub-interval features. However, challenges persist due to irreparable outliers in reconstructed curves and inadequate characterization of equivalent features across non-consecutive intervals, leading to frequent oscillations and single-interval mutations in hydro-wind-solar power transmission schedules. These issues impose excessive regulation stress on hydropower systems and hinder dispatch plan adaptability. Consequently, refined modeling of complex load demands in receiving-end grids is critical for synergistic accommodation of hydro-wind-solar generation, addressing operational bottlenecks in high-renewable-penetration power systems.

Current research on hydro-wind-solar complementary operation focuses on operational challenges including generation scheduling formulation, dispatch rule extraction, complementary capability analysis, risk-benefit quantification, and joint peak-shaving, with emphasis on long-term energy compensation optimization, short-term flexibility response, and complementary operation effectiveness evaluation. While limited studies have begun addressing multi-day extreme high/low output scenarios inherent to renewable energy extreme generation patterns, systems, such as identification of continuous preventive/emergency dispatch coordination under extreme weather (Junjie R, Ming Z, Zhi Z, et al. Coordination of preventive and emergency dispatch in renewable energy integrated power systems under extreme weather[J]. IET Renewable Power Generation, 2024, 18(7): 1164-1176), and risk-constrained scheduling optimization under extreme conditions (Cai X, Qin Z, Hou Y. Improving wind power utilization under stormy weather condition by risk-limiting unit commitment[J]. IET Renewable Power Generation, 2018, 12(15): 1778-1785). Critical gaps remain in modeling multi-temporal hydropower-electricity coupling characteristics, resolving mutual constraints between reservoir level boundaries and energy dispatch limits, establishing refined hydraulic-electric models for a single station with multiple plants, and accommodating heterogeneous load demands across multiple receiving-end grids under a single plant with multiple receiving-ends. These emerging challenges in mega-basin hydro-wind-solar systems necessitate advanced modeling and optimization frameworks to develop efficient and practical power transmission scheduling solutions that address cross-temporal hydraulic-electric interactions and multi-objective dispatch requirements.

To address these challenges, this invention proposes a medium-term dispatch method for basin-wide hydro-wind-solar systems incorporating short-term load characteristics of multiple receiving-end grids, validated through application testing in an actual complementary energy system. Results demonstrate maintained total basin-wide generation output while achieving significant improvements: 88.6% reduction in power transmission deviations during dry seasons and 69.9% decrease in flood season compared to conventional methods, alongside reduced renewable curtailment. Practical verification confirms superior operational alignment under equivalent electricity generation conditions, proving enhanced adaptability to heterogeneous demand patterns across receiving terminals.

### SUMMARY

This invention addresses the technical challenge of developing a mid-term coordinated dispatch method for hydro-wind-solar hybrid systems incorporating multi-regional daily load profiles. By precisely characterizing heterogeneous load profiles and peak-shaving requirements across receiving ends, it reconstructs power demand trajectories and establishes a multi-objective nested scheduling model optimizing both minimal transmission deviations and maximal generation output. The solution determines efficient multi-day power transmission plan and intraday scheduling processes, enabling coordinated operation of hydro-wind-solar systems across multiple temporal scales.

Technical solutions of the invention.

A mid-term coordinated dispatch method for hydro-wind-solar hybrid systems incorporating multi-regional daily load profiles includes the following steps.

Step 1: A time period partitioning model is established based on provincial-level load peak-valley characteristics, with the optimization criterion of minimizing load variance within homogeneous time period clusters. The objective function is shown in Eq. (1). The constraints are shown in Eq. (2).

$$min Var = {\sum }_{g = 1}^{3} {\sum }_{t ∈ {φ}_{g}} {( {L}_{t} - {\sum }_{t ∈ {φ}_{g}} {L}_{t} / {I}_{g} )}^{2} \qquad ( 1 )$$

$$s . t . \{ \begin{matrix}\vert {x}_{i + 1}^{g} - {x}_{i}^{g} - 1 \vert = 0 , i = 1 \\ \vert {x}_{i + 1}^{g} - {x}_{i}^{g} - 1 \vert = 0 ⋁ \vert {x}_{i}^{g} - {x}_{i - 1}^{g} - 1 \vert = 0 , 1 < i < {I}_{g} \\ \vert {x}_{i}^{g} - {x}_{i - 1}^{g} - 1 \vert = 0 , i = {I}_{g} \\ {x}_{i + 1}^{g} > {x}_{i}^{g}\end{matrix} \qquad ( 2 )$$

where Lₜ is the load at period t, MW. g is the period type: g=1 for valley periods, g=2 for flat periods, g=3 for peak periods. φ_{g} indicates the set of time periods belonging to the gth period type. I_{g} specifies the number of time periods in the gth period type. xᵢ^{g} refers to the ith element in the time period set φ_{g}.

Step 2: A variable step-size search strategy is implemented using Python's NumPy module to solve the time period partitioning model from Step 1, aiming to determine two load classification thresholds Y₁ and Y₂ (Y₁<Y₂). Temporal segments are categorized as follows: valley periods when Lₜ<Y₁, flat periods when Y₁≤Lₜ≤Y₂, and peak periods when Lₜ>Y₂. The specific steps are as follows:

Step 2.1 Sort the load values of each time interval from the original load curve in ascending order to generate an increasing load sequence l₁, l₂, . . . , lₘ, . . . , l_{M}, Compute the average of adjacent load pairs lₘ and lₘ₊₁ to construct a variable step-size search set {y₁, y₂, . . . , yₘ, . . . , y_{M-1} }, where yₘ=(lₘ+lₘ₊₁)/2.

Step 2.2 Define k₁ and k₂ as indices of elements in the search set. Initialize k₁=1, k₂=k₁+1, Y₁=yₖ_{₁}, and Y₂=yₖ_{₂}. Derive the partitioned time-interval sets

$${φ}_{g}^{{k}_{1} , {k}_{2}}$$

for each period type (valley/flat/peak) and calculate the corresponding objective function value Varₖ_{₁}_{,k}_{₂}. Set Var=Varₖ_{₁}_{,k}_{₂}.

Step 2.3 Perform an upward search until reaching the highest load interval. Increment k₁=k₁+1 or k₂=k₂+1 iteratively until k₁=M−2 and k₂=M−1. At each iteration, compute the updated objective function Varₖ_{₁}_{,k}_{₂}. If Var<Varₖ_{₁}_{,k}_{₂}, update Var=Varₖ_{₁}_{,k}_{₂}.

Step 2.4 Determine the optimal objective function value and its corresponding time-interval classification sets φ_{g}.

Step 3: Calculate load characteristic indicators and establish a load reconstruction model. The objective function is shown in Eq. (3), and the constraints include the calculation of the characteristic indicators of the original load curve in Eq. (4), the calculation of the reconstructed load curve characteristic indicators in Eq. (5), and the peak/flat/valley periods for the reconstructed load curve in Eq. (6).

$$min DR = {\sum }_{u = 1}^{5} {w}_{u} \vert \frac{{RCI}_{u} - {CI}_{u}}{{CI}_{u}} \vert \qquad ( 3 )$$

where CIᵤ denotes the characteristic indicators of the original load demand curve. RCIᵤ represents the characteristic indicators of the reconstructed load demand curve. wᵤ indicates the weighting coefficient of the characteristic indicators. DR signifies the discrepancy between the characteristic indicators of the reconstructed and original load demand curves.

$${CI}_{1} = {L}_{ave} {CI}_{2} = {L}_{ave} / {L}_{max} {CI}_{3} = ( {L}_{max} - {L}_{min} ) / {L}_{max} {CI}_{4} = {L}_{ave , peak} / {L}_{ave} {CI}_{5} = {L}_{ave , low} / {L}_{ave} {CI}_{6} = {T}_{max} {CI}_{7} = {T}_{min} \qquad ( 4 )$$

where CI₁, CI₂, CI₃, CI₄, CI₅, CI₆, CI₇ represent daily average load, daily load rate, daily peak-valley difference rate, peak period load ratio, valley period load ratio, peak occurrence time, and valley occurrence time of the original load curve, respectively. Lₐᵥₑ, Lₘₐₓ, Lₘᵢₙ represent the daily average, maximum, and minimum loads of the original load curve, respectively. L_{ave, peak}, L_{ave,low} represent the average loads during peak and valley periods of the original load curve, respectively. Tₘₐₓ, Tₘᵢₙ represent times of daily peak and valley load occurrences of the original load curve, respectively.

$${RCI}_{1} = {L}_{ave}^{r e} {RCI}_{2} = {L}_{ave}^{re} / {L}_{max}^{re} {RCI}_{3} = ( {L}_{max}^{re} - {L}_{min}^{re} ) / {L}_{max}^{re} {RCI}_{4} = {L}_{ave , peak}^{re} / {L}_{ave}^{re} {RCI}_{5} = {L}_{ave , low}^{re} / {L}_{ave}^{re} {RCI}_{6} = {T}_{max}^{re} = {T}_{max} {RCI}_{7} = {T}_{min}^{re} = {T}_{min} \qquad ( 5 )$$

where RCI₁, RCI₂, RCI₃, RCI₄, RCI₅, RCI₆, RCI₇ represent daily average load, daily load rate, daily peak-valley difference rate, peak period load ratio, valley period load ratio, peak occurrence time, and valley occurrence time of the reconstructed load demand curve, respectively. Lₐᵥₑ, Lₘₐₓ, Lₘᵢₙ represent the daily average, maximum, and minimum loads of the reconstructed load demand curve, respectively. L_{ave, peak}, L_{ave,low} represent the average loads during peak and valley periods of the reconstructed load demand curve, respectively. Tₘₐₓ, Tₘᵢₙ represent times of daily peak and valley load occurrences of the reconstructed load demand curve, respectively.

$${L}_{t}^{r e} = {L}_{low}^{r e} ( t ∈ {φ}_{1} ) \qquad ( 6 )$$

$${L}_{t}^{r e} = {L}_{flat}^{re} ( t ∈ {φ}_{2} )$$

$${L}_{t}^{r e} = {L}_{p e a k}^{r e} ( t ∈ {φ}_{3} )$$

where

$${L}_{low}^{re} , {L}_{flat}^{re} , {L}_{peak}^{re}$$

denote the values of the reconstructed load curve during valley, flat, and peak periods, respectively.

Step 4: Construct a uniform step-size search method using the Python-Numpy computational package to solve the load reconstruction model in Step 3, as detailed below:

Step 4.1 Identify the maximum load Lₘₐₓ and minimum load Lₘᵢₙ from the load sequence. Determine the search step size sw, and generate an equidistant search set {r₁, r₂, . . . , rₐ, . . . , r_{A}}, where rₐ=Lₘᵢₙ+sw*(a−1) . a represents the element index in the search set. A denotes the total number of elements in the set.

Step 4.2 Define b₁, b₂, b₃ as sequential indices of elements in the search set. Initialize b₁=1, b₂=b₁+1, b₃=b₂+1, and set

$${L}_{l o w}^{r e} = {r}_{{b}_{1}} , {L}_{flat}^{r e} = {r}_{{b}_{2}} , {L}_{peak}^{r e} = {r}_{{b}_{3}} .$$

Generate the corresponding reconstructed load curve, compute the load characteristic indicators, and evaluate the objective discrepancy rate DR_{b}_{₁}_{,b}_{₂}_{,b}_{₃}. Set DR=DR_{b}_{₁}_{,b}_{₂}_{,b}_{₃}.

Step 4.3 Perform incremental operations on variables b₁, b₂, b₃ until b₁=A−2, b₂=A−1, b₃=A. Calculate the corresponding objective function value DR=DR_{b}_{₁}_{,b}_{₂}_{,b}_{₃}. If DR<DR=DR_{b}_{₁}_{,b}_{₂}_{,b}_{₃}, update DR=DR=DR_{b}_{₁}_{,b}_{₂}_{,b}_{₃} to identify the reconstructed load curve corresponding to the optimal objective function value.

Step 4.4 Determine the optimal objective function value DR and its corresponding reconstructed load curve through the optimization process.

Step 5: Construct a short- and medium-term nested scheduling model for basin-wide hydro-wind-solar systems, accounting for left/right bank interdependencies and upstream-downstream hydraulic coupling in cascade hydropower stations, while integrating medium- and short-term dispatch constraints.

The objective function for maximizing power generation is as follows:

$$max E = {\sum }_{n = 1}^{N} {\sum }_{j = 1}^{2} {\sum }_{d = 1}^{D} {P}_{n , j , d} Δ t \qquad ( 7 )$$

$${P}_{n , j , d} = {P}_{n , j , d}^{hydro} + {P}_{n , j , d}^{w} + {P}_{n , j , d}^{solar}$$

where E is the objective function of maximum power generation, MWh.

$${P}_{n , j , d}^{hydro}$$

is the output of hydropower plant j at station n on day d, MW.

$${P}_{n , j , d}^{w i n d} , {P}_{n , j , d}^{solar}$$

are the outputs of wind and solar plants bundled with hydropower plant j at station n on day d, respectively, MW. P_{n,j,d} is total bundled output (hydro-wind-solar) from plant j at station n on day d, MW. Δt is daily duration in hours, h. n, N are index and total number of hydropower stations. j is the plant index (j=1: left-bank plant; j=2: right-bank plant). d and D are day index and total dispatch horizon, respectively.

The objective function for minimizing power transmission deviation is as follows:

$$min ED = {\sum }_{s = 1}^{S} {\sum }_{n = 1}^{N} {\sum }_{j = d}^{2} {\sum }_{d = 1}^{D} {\sum }_{t = 1}^{T} {( {P}_{s , n , j , d , t}^{t r a n s} - {η}_{s , n , j , d} {ξ}_{s} ( t ) )}^{2} \qquad ( 8 )$$

where ED is the objective function quantifying power transmission deviation, MW².

$${P}_{s , n , j , d , t}^{t r a n s}$$

is the scheduled power transmission from plant j at station n to province s at time t on day d, MW. ξₛ(t) is the load demand of province s, represented by the reconstructed load curve from Step 4. η_{s,n,j,d} is the scaling factor for load demand at receiving-end province s. s, S are province index and total number of provinces. t and T are time interval index and total number of intervals, respectively.

In addition to conventional constraints, the model incorporates nested medium- and short-term energy balance constraints, where the daily energy output derived from medium-term dispatch must equal the sum of intraday generation across all time intervals, as specified in Eq. (9).

$${P}_{n , j , d}^{hydro} = {\sum }_{t = 1}^{T} {P}_{n , j , d , t}^{hydro} / T \qquad ( 9 )$$

$${P}_{n , j , d}^{wind} = {\sum }_{t = 1}^{T} {P}_{n , j , d , t}^{wind} / T$$

$${P}_{n , j , d}^{solar} = {\sum }_{t = 1}^{T} {P}_{n , j , d , t}^{solar} / T$$

$${P}_{s , n , j , d}^{trans} = {\sum }_{t = 1}^{T} {P}_{s , n , j , d , t}^{trans} / T$$

Step 6: On the Gurobi solver platform, implement computationally efficient optimization by converting the medium-term s dispatch method for basin-wide hydro-wind-solar systems into a mixed-integer linear programming (MILP) formulation via Python programming. The specific steps are as follows.

Step 6.1 The multi-objective optimization model incorporating both power generation maximization and power transmission deviation minimization is converted into a single-objective formulation using the constraint transformation method. This is achieved by reconfiguring the power generation maximization objective as a constraint under the deviation minimization objective, as detailed in Eq. (10).

$$min ED = {\sum }_{s = 1}^{S} {\sum }_{n = 1}^{N} {\sum }_{j = d}^{2} {\sum }_{d = 1}^{D} {\sum }_{t = 1}^{T} {( {P}_{s , n , j , d , t}^{t r a n s} - {η}_{s , n , j , d} {ξ}_{s} ( t ) )}^{2} \qquad ( 10 )$$

$$s . t . E \geq {E}^{set}$$

where E^{set} denotes the total generation requirement of the basin-wide hydro-wind-solar system during the dispatch period, MWh. Initial value of E^{set} is defined as the maximum generation capacity when power transmission deviation objectives are excluded, which corresponds to the optimal objective function value of the daily generation maximization model.

Step 6.2 For the univariate nonlinear relationship between water level and reservoir storage, apply piecewise linearization for processing; for the bivariate nonlinear relationship in hydropower generation functions, implement linearization using a two-dimensional linear interpolation method based on parallelogram partitioning.

Step 6.3 A set of non-dominated solutions (Pareto front) for the multi-objective optimization model is generated by iteratively relaxing generation capacity constraints.

Step 6.4 Calculate the comprehensive benefit index to select the optimal dispatch plan from the solution set, with the index formulation defined in Eq. (11).

$$F = \frac{E - {E}_{min}}{{E}_{max} - {E}_{min}} + \frac{E {D}_{max} - E D}{E {D}_{max} - E {D}_{min}} \qquad ( 11 )$$

Compared to existing methodologies, the proposed invention demonstrates the following advantages. First, the load demand reconstruction method based on peak-flat-valley period division generates reconstructed curves that precisely characterize load profile characteristics and variation patterns of receiving-end power grids. Second, the mid-term coordinated dispatch method for hydro-wind-solar hybrid systems incorporating multi-regional daily load profiles significantly reduces deviations between power transmission schedules and receiving-end power demand while maintaining basin-wide total generation output, thereby effectively alleviating regulation stress on receiving-end provincial power grids. Third, the approach significantly decreases renewable energy curtailment and enhances clean energy accommodation capacity.

### DESCRIPTION OF DRAWINGS

FIG. 1 is the time period partitioning principle diagram.

FIG. 2 is the medium-short-term nested dispatch configuration schematic.

FIG. 3 is the parallelogram grid pattern schematic.

FIG. 4 is the power transmission deviation correlation curve (dry season).

FIG. 5 is the power transmission deviation correlation curve (flood season).

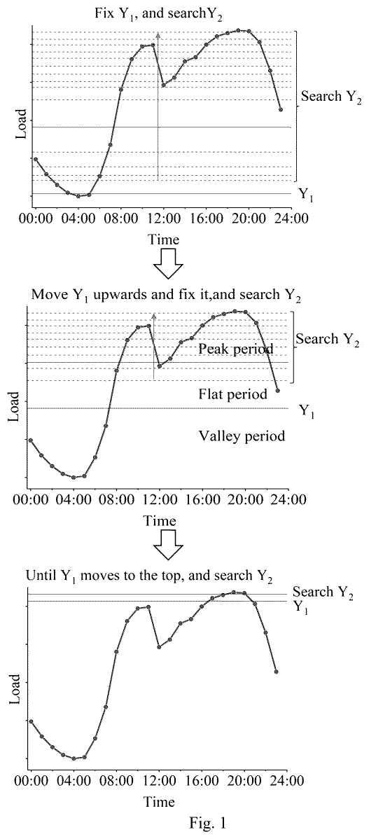

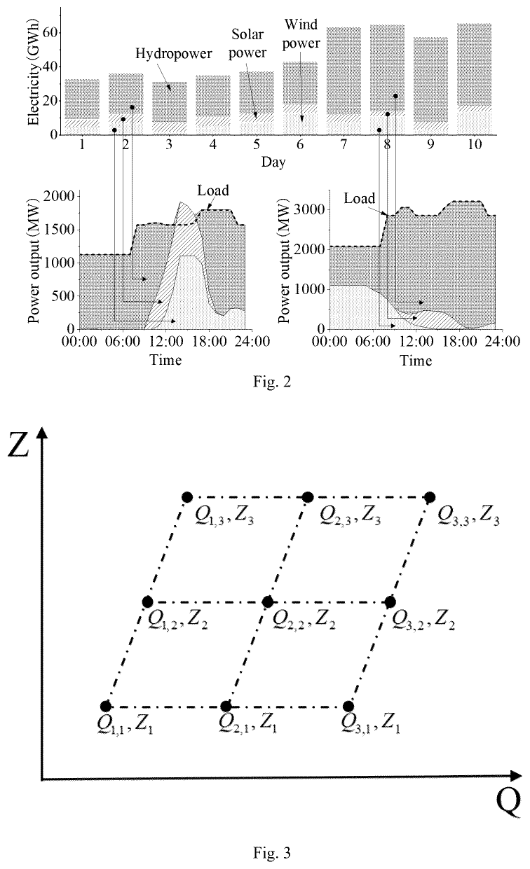

### DETAILED DESCRIPTION

The specific embodiments of the invention are further described below in conjunction with the accompanying drawings and technical solutions.

A mid-term coordinated dispatch method for hydro-wind-solar hybrid systems incorporating multi-regional daily load profiles, with the following implementation steps:

Step 1: A time period partitioning model is established based on provincial-level load peak-valley characteristics, with the optimization criterion of minimizing load variance within homogeneous time period clusters. The objective function is shown in Eq. (12). The constraints are shown in Eq. (13).

$$min Var = {\sum }_{g = 1}^{3} {\sum }_{t ∈ {φ}_{s}} {( {L}_{t} - {\sum }_{t ∈ {φ}_{g}} {L}_{t} / {I}_{g} )}^{2} \qquad ( 12 )$$

$$s . t . \{ \begin{matrix}\begin{matrix}\begin{matrix}\vert {x}_{i + 1}^{g} - {x}_{i}^{g} - 1 \vert = 0 , i = 1 \\ \vert {x}_{i + 1}^{g} - {x}_{i}^{g} - 1 \vert = 0 ⋁ \vert {x}_{i}^{g} - {x}_{i - 1}^{g} - 1 \vert = 0 , 1 < i < {I}_{g}\end{matrix} \\ \vert {x}_{i}^{g} - {x}_{i - 1}^{g} - 1 \vert = 0 , i = {I}_{g}\end{matrix} \\ {x}_{i + 1}^{g} > {x}_{i}^{g}\end{matrix} \qquad ( 13 )$$

where Lₜ is the load at period t, MW. g is the period type: g=1 for valley periods, g=2 for flat periods, g=3 for peak periods. φ_{g} indicates the set of time periods belonging to the gth period type. I_{g} specifies the number of time periods in the gth period type.

$${x}_{i}^{g}$$

refers to the ith element in the time period set φ_{g}.

Step 2: A variable step-size search strategy is implemented using Python's NumPy module to solve the time period partitioning model from Step 1, aiming to determine two load classification thresholds Y₁ and Y₂ (Y₁<Y₂). Temporal segments are categorized as follows: valley periods when Lₜ<Y₁, flat periods when Y₁≤Lₜ≤Y₂, and peak periods when Lₜ>Y₂. The specific steps are as follows:

Step 2.1 Sort the load values of each time interval from the original load curve in ascending order to generate an increasing load sequence l₁, l₂, . . . , lₘ, . . . , l_{M}, Compute the average of adjacent load pairs lₘ and lₘ₋₁to construct a variable step-size search set {y₁, y₂, . . . , yₘ, . . . , y_{M-1} }, where yₘ=(lₘ+lₘ₊₁)/2.

Step 2.2 Define k₁ and k₂ as indices of elements in the search set. Initialize k₁=1, k₂=k₁+1, Y₁=yₖ_{₁}, and Y₂=yₖ_{₂}. Derive the partitioned time-interval sets

$${φ}_{g}^{{k}_{1} , {k}_{2}}$$

for each period type (valley/flat/peak) and calculate the corresponding objective function value Varₖ_{₁}_{,k}_{₂}. Set Var=Varₖ_{₁}_{,k}_{₂}.

Step 2.3 Perform an upward search until reaching the highest load interval. Increment k₁=k₁+1 or k₂=k₂+1 iteratively until k₁=M−2 and k₂=M−1. At each iteration, compute the updated objective function Varₖ_{₁}_{,k}_{₂}. If Var<Varₖ_{₁}_{,k}_{₂}, update Var=Varₖ_{₁}_{,k}_{₂}.

Step 2.4 Determine the optimal objective function value and its corresponding time-interval classification sets φ_{g}.

Step 3: Calculate load characteristic indicators and establish a load reconstruction model. The objective function is shown in Eq. (14), and the constraints include the calculation of the characteristic indicators of the original load curve in Eq. (15), the calculation of the reconstructed load curve characteristic indicators in Eq. (16), and the peak/flat/valley periods for the reconstructed load curve in Eq. (17).

$$min DR = {\sum }_{u = 1}^{5} {w}_{u} \vert \frac{R C {I}_{u} - C {I}_{u}}{C {I}_{u}} \vert \qquad ( 14 )$$

where CIᵤ denotes the characteristic indicators of the original load demand curve. RCIᵤ represents the characteristic indicators of the reconstructed load demand curve. wᵤ indicates the weighting coefficient of the characteristic indicators. DR signifies the discrepancy between the characteristic indicators of the reconstructed and original load demand curves.

$$C {I}_{1} = {L}_{a v e} \qquad ( 15 )$$

$$C {I}_{2} = {L}_{a v e} / {L}_{max}$$

$$C {I}_{3} = ( {L}_{max} - {L}_{min} ) / {L}_{max}$$

$$C {I}_{4} = {L}_{ave , peak} / {L}_{a v e}$$

$$C {I}_{5} = {L}_{ave , low} / {L}_{a v e}$$

$$C {I}_{6} = {T}_{max}$$

$$C {I}_{7} = {T}_{min}$$

where CI₁, CI₂, CI₃, CI₄, CI₅, CI₆, CI₇ represent daily average load, daily load rate, daily peak-valley difference rate, peak period load ratio, valley period load ratio, peak occurrence time, and valley occurrence time of the original load curve, respectively. Lₐᵥₑ, Lₘₐₓ, Lₘᵢₙ represent the daily average, maximum, and minimum loads of the original load curve, respectively. L_{ave, peak}, L_{ave,low} represent the average loads during peak and valley periods of the original load curve, respectively. Tₘₐₓ, Tₘᵢₙ represent times of daily peak and valley load occurrences of the original load curve, respectively.

$$R C {I}_{1} = {L}_{ave}^{r e} \qquad ( 16 )$$

$$RC {I}_{2} = {L}_{ave}^{r e} / {L}_{m \partial K}^{r e}$$

$$RC {I}_{3} = ( {L}_{max}^{r e} - {L}_{min}^{r e} ) / {L}_{max}^{r e}$$

$$RC {I}_{4} = {L}_{ave , peak}^{r e} / {L}_{ave}^{r e}$$

$$RC {I}_{5} = {L}_{ave , low}^{r e} / {L}_{ave}^{r e}$$

$$RC {I}_{6} = {T}_{max}^{r e} = {T}_{max}$$

$$RC {I}_{7} = {T}_{min}^{r e} = {T}_{min}$$

where RCI₁, RCI₂, RCI₃, RCI₄, RCI₅, RCI₆, RCI₇ represent daily average load, daily load rate, daily peak-valley difference rate, peak period load ratio, valley period load ratio, peak occurrence time, and valley occurrence time of the reconstructed load demand curve, respectively. Lₐᵥₑ, Lₘₐₓ, Lₘᵢₙ represent the daily average, maximum, and minimum loads of the reconstructed load demand curve, respectively. L_{ave, peak}, L_{ave,low} represent the average loads during peak and valley periods of the reconstructed load demand curve, respectively. Tₘₐₓ, Tₘᵢₙ represent times of daily peak and valley load occurrences of the reconstructed load demand curve, respectively.

$${L}_{t}^{r e} = {L}_{low}^{r e} ( t ∈ {φ}_{1} ) \qquad ( 17 )$$

$${L}_{t}^{r e} = {L}^{r e} ( t ∈ {φ}_{2} )$$

$${L}_{t}^{r e} = {L}_{p e a k}^{r e} ( t ∈ {φ}_{3} )$$

where

$${L}_{low}^{re} , {L}_{flat}^{re} , {L}_{peak}^{re}$$

denote the values of the reconstructed load curve during valley, flat, and peak periods, respectively.

Step 4: Construct a uniform step-size search method using the Python-Numpy computational package to solve the load reconstruction model in Step 3, as detailed below:

Step 4.1 Identify the maximum load Lₘₐₓ and minimum load Lₘᵢₙ from the load sequence. Determine the search step size sw, and generate an equidistant search set {r₁, r₂, . . . , rₐ, . . . r_{A}}, where rₐ=Lₘᵢₙ+sw*(a−₁). a represents the element index in the search set. A denotes the total number of elements in the set.

Step 4.2 Define b₁, b₂, b₃ as sequential indices of elements in the search set. Initialize b₁=1, b₂=b₁+1, b₃=b₂+1, and set

$${L}_{l o w}^{r e} = {r}_{{b}_{1}} , {L}_{flat}^{r e} = {r}_{{b}_{2}} , {L}_{peok}^{r e} = {r}_{{b}_{3}} .$$

Generate the corresponding reconstructed load curve, compute the load characteristic indicators, and evaluate the objective discrepancy rate DR_{b}_{₁}_{,b}_{₂}_{,b}_{₃}. Set DR=DR_{b}_{₁}_{,b}_{₂}_{,b}_{₃}.

Step 4.3 Perform incremental operations on variables b₁, b₂, b₃ until b₁=A−2, b₂=A−1,b₃=A. Calculate the corresponding objective function value DR_{b}_{₁}_{,b}_{₂}_{,b}_{₃}. If DR<DR_{b}_{₁}_{,b}_{₂}_{,b}_{₃}, update DR=DR_{b}_{₁}_{,b}_{₂}_{,b}_{₃} to identify the reconstructed load curve corresponding to the optimal objective function value.

Step 4.4 Determine the optimal objective function value DR and its corresponding reconstructed load curve through the optimization process.

Step 5: Construct a short- and medium-term nested scheduling model for basin-wide hydro-wind-solar systems, accounting for left/right bank interdependencies and upstream-downstream hydraulic coupling in cascade hydropower stations, while integrating medium- and short-term dispatch constraints.

The objective function for maximizing power generation is as follows:

$$max E = {\sum }_{n = 1}^{N} {\sum }_{j = 1}^{2} {\sum }_{d = 1}^{D} {P}_{n , j , d} Δ t \qquad ( 18 )$$

$${P}_{n , j , d} = {P}_{n , j , d}^{hydro} + {P}_{n , j , d}^{wind} + {P}_{n , j , d}^{solar}$$

where E is the objective function of maximum power generation, MWh.

$${P}_{n , j , d}^{hydro}$$

is the output of hydropower plant j at station n on day d, MW.

$${P}_{n , j , d}^{w i n d} , {P}_{n , j , d}^{solar}$$

are the outputs of wind and solar plants bundled with hydropower plant j at station n on day d, respectively, MW. P_{n,j,d} is total bundled output (hydro-wind-solar) from plant j at station n on day d, MW. Δt is daily duration in hours, h. n, N are index and total number of hydropower stations. j is the plant index (j=1: left-bank plant; j=2: right-bank plant). d and D are day index and total dispatch horizon, respectively.

The objective function for minimizing power transmission deviation is as follows:

$$min ED = {\sum }_{s = 1}^{S} {\sum }_{n = 1}^{N} {\sum }_{j = 1}^{2} {\sum }_{d = 1}^{D} {\sum }_{t = 1}^{T} {( {P}_{s , n , j , d , t}^{t r a n s} - {η}_{s , n , j , d} {ξ}_{s} ( t ) )}^{2} \qquad ( 19 )$$

where ED is the objective function quantifying power transmission deviation, MW².

$${P}_{s , n , j , d , t}^{t r a n s}$$

is the transmitted power from plant j at station n to province s at time t on day d, MW. ξₛ(t) is the load demand of province s, represented by the reconstructed load curve from Step 4. η_{s,n,j,d} is the scaling factor for load demand at receiving-end province s. s, S are province index and total number of provinces. t, T are time interval index and total number of intervals.

In addition to conventional constraints, the model incorporates nested medium- and short-term energy balance constraints, where the daily energy output derived from medium-term dispatch must equal the sum of intraday generation across all time intervals, as specified in Eq. (10).

$${P}_{n , j , d}^{hydro} = {\sum }_{t = 1}^{T} {P}_{n , j , d , t}^{hydro} / T \qquad ( 20 )$$

$${P}_{n , j , d}^{wind} = {\sum }_{t = 1}^{T} {P}_{n , j , d , t}^{wind} / T$$

$${P}_{n , j , d}^{solar} = {\sum }_{t = 1}^{T} {P}_{n , j , d , t}^{solar} / T$$

$${P}_{s , n , j , d}^{trans} = {\sum }_{t = 1}^{T} {P}_{s , n , j , d , t}^{hydro} / T$$

Step 6: On the Gurobi solver platform, implement computationally efficient optimization by converting the medium-term dispatch method for basin-wide hydro-wind-solar systems into a mixed-integer linear programming (MILP) formulation via Python programming. The specific steps are as follows.

Step 6.1 The multi-objective optimization model incorporating both power generation maximization and power transmission deviation minimization is converted into a single-objective formulation using the constraint transformation method. This is achieved by reconfiguring the power generation maximization objective as a constraint under the deviation minimization objective, as detailed in Eq. (21).

$$min ED = {\sum }_{s = 1}^{S} {\sum }_{n = 1}^{N} {\sum }_{j = 1}^{2} {\sum }_{d = 1}^{D} {\sum }_{t = 1}^{T} {( {P}_{s , n , j , d , t}^{t r a n s} - {η}_{s , n , j , d} {ξ}_{s} ( t ) )}^{2} \qquad ( 21 )$$

$$s . t . E \geq {E}^{set}$$

where E^{set} denotes the total generation requirement of the basin-wide hydro-wind-solar system during the dispatch period, MWh. Initial value of E^{set} is defined as the maximum generation capacity when power transmission deviation objectives are excluded, which corresponds to the optimal objective function value of the daily generation maximization model.

Step 6.2 For the univariate nonlinear relationship between water level and reservoir storage, apply piecewise linearization for processing; for the bivariate nonlinear relationship in hydropower generation functions, implement linearization using a two-dimensional linear interpolation method based on parallelogram partitioning.

Step 6.3 A set of non-dominated solutions (Pareto front) for the multi-objective optimization model is generated by iteratively relaxing generation capacity constraints.

Step 6.4 Calculate the comprehensive benefit index to select the optimal dispatch plan from the solution set, with the index formulation defined in Eq. (22).

$$F = \frac{E - {E}_{min}}{{E}_{max} - {E}_{min}} + \frac{E {D}_{max} - E D}{E {D}_{max} - E {D}_{min}} \qquad ( 22 )$$

The proposed methodology is validated using a basin hydro-wind-solar hybrid system case study. The cascade hydropower stations selected include WDD, BHT, XLD, and XJB, with a total installed capacity of 46,460 MW. Currently, 10,487 MW of renewable energy is being integrated into this cascade hydropower system, delivering clean energy to southeastern load centers via ultra-high-voltage direct current (UHVDC) transmission. The simulation case study focuses on these four hydropower stations and the bundled wind and solar generation clusters to demonstrate the method's efficacy. Given that consecutive extreme output scenarios of renewable energy predominantly occur within ten-day periods, a 10-day scheduling horizon is adopted. Operational analyses are conducted for two representative periods: dry season and flood season in a specific year, referencing actual operational data including inter-basin inflow, initial/final reservoir levels, and load profiles.

To fully reflect the peak-valley characteristics of receiving-end loads, this study selects the hourly load sequence from the day with the maximum peak-to-valley difference within the scheduling period for load reconstruction. Tables 1 and 2 compare the characteristic metrics between reconstructed and original load curves, respectively. The results demonstrate minimal deviations across all metrics. Specifically, daily load factor and daily peak-to-valley difference rate remain identical, confirming the reconstructed curves' precision in capturing intraday load imbalance and variation magnitude. Daily average load discrepancies are within 1%, indicating equivalent daily load levels between reconstructed and original curves. Peak-period load rate and valley-period load rate deviations are below 6.5%, proving the reconstructed curves comprehensively preserve peak/valley load dynamics. Correlation coefficients between reconstructed and original curves exceed 90%, validating their overall consistency.

TABLE 1
Comparison of load characteristic metrics (dry season)

| | | | | Daily | Peak | Valley | |
|---|---|---|---|---|---|---|---|
| | | Daily | Daily | Peak-Valley | Period | Period | |
| | Benchmarking | Average | Load | Difference | Load | Load | Correlation |
| Province | Metrics | Load/MW | Factor | Rate | Rate | Rate | Coefficient |
| GD | Original Load | 84262.20 | 0.83 | 0.41 | 1.17 | 0.77 | |
| | Reconstructed | 84283.20 | 0.83 | 0.41 | 1.21 | 0.72 | 97.53% |
| | Load | | | | | | |
| | Gap | 0.02% | 0.00% | 0.00% | 3.42% | −6.49% | / |
| GX | Original Load | 19267.34 | 0.82 | 0.38 | 1.19 | 0.79 | |
| | Reconstructed | 19140.43 | 0.82 | 0.38 | 1.22 | 0.76 | 95.98% |
| | Load | | | | | | |
| | Gap | −0.66% | 0.00% | 0.00% | 2.52% | −3.80% | / |
| JS | Original Load | 68999.78 | 0.91 | 0.23 | 1.08 | 0.87 | |
| | Reconstructed | 69015.38 | 0.91 | 0.23 | 1.1 | 0.85 | 96.14% |
| | Load | | | | | | |
| | Gap | 0.02% | 0.00% | 0.00% | 1.85% | −2.30% | / |
| ZJ | Original Load | 59830.77 | 0.84 | 0.36 | 1.13 | 0.78 | |
| | Reconstructed | 59803.83 | 0.84 | 0.36 | 1.19 | 0.76 | 92.50% |
| | Load | | | | | | |
| | Gap | −0.05% | 0.00% | 0.00% | 5.31% | −2.56% | / |
| SH | Original Load | 17193.67 | 0.88 | 0.34 | 1.11 | 0.78 | |
| | Reconstructed | 17190.13 | 0.88 | 0.34 | 1.14 | 0.75 | 97.19% |
| | Load | | | | | | |
| | Gap | −0.02% | 0.00% | 0.00% | 2.70% | −3.85% | / |
| YN | Original Load | 22062.82 | 0.89 | 0.26 | 1.1 | 0.86 | |
| | Reconstructed | 22043.75 | 0.89 | 0.26 | 1.12 | 0.83 | 96.82% |
| | Load | | | | | | |
| | Gap | −0.09% | 0.00% | 0.00% | 1.82% | −3.49% | / |
| SC | Original Load | 27132.64 | 0.86 | 0.32 | 1.12 | 0.83 | |
| | Reconstructed | 27085.92 | 0.86 | 0.32 | 1.16 | 0.79 | 96.11% |
| | Load | | | | | | |
| | Gap | −0.17% | 0.00% | 0.00% | 3.57% | −4.82% | / |

TABLE 2
Comparison of load characteristic metrics (flood season)

| | | | | Daily | Peak | Valley | |
|---|---|---|---|---|---|---|---|
| | | Daily | Daily | Peak-Valley | Period | Period | |
| | Benchmarking | Average | Load | Difference | Load | Load | Correlation |
| Province | Metrics | Load/MW | Factor | Rate | Rate | Rate | Coefficient |
| GD | Original Load | 102092.10 | 0.84 | 0.37 | 1.16 | 0.79 | |
| | Reconstructed | 101634.00 | 0.84 | 0.37 | 1.19 | 0.75 | 97.57% |
| | Load | | | | | | |
| | Gap | −0.45% | 0.00% | 0.00% | 2.59% | −5.06% | / |
| GX | Original Load | 23433.81 | 0.87 | 0.3 | 1.09 | 0.81 | |
| | Reconstructed | 23691.99 | 0.89 | 0.3 | 1.13 | 0.79 | 94.93% |
| | Load | | | | | | |
| | Gap | 1.10% | 2.30% | 0.00% | 3.67% | −2.47% | / |
| JS | Original Load | 107831.50 | 0.9 | 0.23 | 1.09 | 0.88 | |
| | Reconstructed | 107813.70 | 0.9 | 0.23 | 1.11 | 0.86 | 96.05% |
| | Load | | | | | | |
| | Gap | −0.02% | 0.00% | 0.00% | 1.83% | −2.27% | / |
| ZJ | Original Load | 74068.25 | 0.83 | 0.38 | 1.15 | 0.77 | |
| | Reconstructed | 73795.32 | 0.83 | 0.38 | 1.2 | 0.75 | 95.44% |
| | Load | | | | | | |
| | Gap | −0.37% | 0.00% | 0.00% | 4.35% | −2.60% | / |
| SH | Original Load | 27395.72 | 0.84 | 0.41 | 1.15 | 0.75 | |
| | Reconstructed | 27394.32 | 0.84 | 0.41 | 1.19 | 0.73 | 95.24% |
| | Load | | | | | | |
| | Gap | −0.01% | 0.00% | 0.00% | 3.48% | −2.67% | / |
| YN | Original Load | 19416.13 | 0.87 | 0.3 | 1.12 | 0.83 | |
| | Reconstructed | 19412.20 | 0.87 | 0.3 | 1.15 | 0.8 | 96.63% |
| | Load | | | | | | |
| | Gap | −0.02% | 0.00% | 0.00% | 2.68% | −3.61% | / |
| SC | Original Load | 30334.07 | 0.84 | 0.37 | 1.13 | 0.77 | |
| | Reconstructed | 30399.98 | 0.85 | 0.37 | 1.18 | 0.75 | 94.55% |
| | Load | | | | | | |
| | Gap | 0.22% | 1.19% | 0.00% | 4.42% | −2.60% | / |

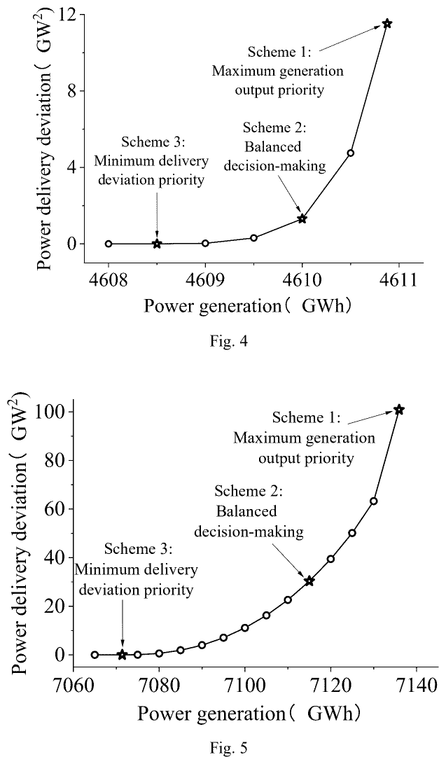

The proposed method converts the multi-objective model into a single-objective model through a constraint transformation approach and obtains a set of non-dominated solutions by progressively relaxing constraints. FIGS. 4 and 5 illustrate the relationship between generation output and power transmission deviation, respectively. The curves demonstrate a clear trade-off: above a specific generation threshold, increased power generation leads to higher transmission deviations, whereas below this threshold, deviations stabilize at minimum levels. Solely maximizing generation output exacerbates transmission deviations, increasing regulation stress on receiving-end grids and hindering clean energy accommodation. Conversely, minimizing transmission deviation compromises generation efficiency. Thus, optimal dispatch requires balancing generation-side benefits with receiving-end demand.

A comparative analysis is conducted among three dispatch schemes: maximum generation output priority (Scheme 1), balanced decision-making (Scheme 2), minimum transmission deviation priority (Scheme 3).

From the perspective of generation output, in the dry season case, the total basin-wide generation outputs for Schemes 1, 2, and 3 are 4,610.87 GWh, 4,610.00 GWh, and 4,608.50 GWh respectively, with Scheme 2 and Scheme 3 exhibiting reductions of 0.02% and 0.05% compared to Scheme 1. In the flood season case, the total basin-wide generation outputs for the three schemes measure 7,135.93 GWh, 7,115.00 GWh, and 7,071.39 GWh, where Scheme 2 and Scheme 3 demonstrate tiny reductions of 0.29% and 0.91% relative to Scheme 1.

From the perspective of transmission deviation, in the dry season case, the transmission deviations for Schemes 1, 2, and 3 are 11.52 GW², 1.31 GW², and 0 respectively, with Scheme 2 and Scheme 3 achieving reductions of 88.6% and 100% compared to Scheme 1. In the flood season case, the transmission deviations for the three schemes measure 100.86 GW², 30.36 GW², and 0, where Scheme 2 and Scheme 3 demonstrate substantial reductions of 69.9% and 100% relative to Scheme 1.

1. A mid-term coordinated dispatch method for hydro-wind-solar hybrid systems incorporating multi-regional daily load profiles includes the following steps:
Step 1: a time period partitioning model is established based on provincial-level load peak-valley characteristics, with the optimization criterion of minimizing load variance within homogeneous time period clusters; the objective function is shown in Eq. (23); the constraints are shown in Eq. (24):
$$min Var = {\sum }_{g = 1}^{3} {\sum }_{t ∈ {φ}_{g}} {( {L}_{t} - {\sum }_{t ∈ {φ}_{g}} {L}_{t} / {I}_{g} )}^{2} \qquad ( 23 )$$
$$s . t . \{ \begin{matrix}\vert {x}_{i + 1}^{g} - {x}_{i}^{g} - 1 \vert = 0 , i = 1 \\ \vert {x}_{i + 1}^{g} - {x}_{i}^{g} - 1 \vert = 0 ⋁ \vert {x}_{i}^{g} - {x}_{i - 1}^{g} - 1 \vert = 0 , 1 < i < {I}_{g} \\ \vert {x}_{i}^{g} - {x}_{i - 1}^{g} - 1 \vert = 0 , i = {I}_{g} \\ {x}_{i + 1}^{g} > {x}_{i}^{g}\end{matrix} \qquad ( 24 )$$
where Lₜ is the load at period t, MW; g is the period type: g=1 for valley periods, g=2 for flat periods, g=3 for peak periods; φ_{g} indicates the set of time periods belonging to the gth period type; I_{g} specifies the number of time periods in the gth period type;
$${x}_{i}^{g}$$
refers to the ith element in the time period set φ_{g};
Step 2: a variable step-size search strategy is implemented using Python's NumPy module to solve the time period partitioning model from Step 1, aiming to determine two load classification thresholds Y₁ and Y₂ (Y₁<Y₂). Temporal segments are categorized as follows: valley periods when Lₜ<Y₁, flat periods when Y₁≤Lₜ≤Y₂, and peak periods when Lₜ>Y₂; the specific steps are as follows:
Step 2.1 sort the load values of each time interval from the original load curve in ascending order to generate an increasing load sequence l₁, l₂, . . . , lₘ, . . . , l_{M}, Compute the average of adjacent load pairs lₘ and lₘ₊₁ to construct a variable step-size search set {y₁, y₂, . . . , yₘ, . . . , y_{M-1} }, where yₘ=(lₘ+lₘ₊₁)/2;
Step 2.2 define k₁ and k₂ as indices of elements in the search set. Initialize k₁=1, k₂=k₁+1, Y₁=yₖ_{₁}, and Y₂=yₖ_{₂}; derive the partitioned time-interval sets
$${φ}_{g}^{{k}_{1} , {k}_{2}}$$
for each period type (valley/flat/peak) and calculate the corresponding objective function value Varₖ_{₁}_{,k}_{₂}; set Var=Varₖ_{₁}_{,k}_{₂};
Step 2.3 perform an upward search until reaching the highest load interval; increment k₁=k₁+1 or k₂=k₂+1 iteratively until k₁=M−2 and k₂=M−1; at each iteration, compute the updated objective function Varₖ_{₁}_{,k}_{₂}; if Var<Varₖ_{₁}_{,k}_{₂}, update Var=Varₖ_{₁}_{,k}_{₂};
Step 2.4 determine the optimal objective function value and its corresponding time-interval classification sets φ_{g};
Step 3: calculate load characteristic indicators and establish a load reconstruction model; the objective function is shown in Eq. (25), and the constraints include the calculation of the characteristic indicators of the original load curve in Eq. (26), the calculation of the reconstructed load curve characteristic indicators in Eq. (27), and the peak/flat/valley periods for the reconstructed load curve in Eq. (28):
$$min DR = {\sum }_{u = 1}^{5} {w}_{u} \vert \frac{R C {I}_{u} - C {I}_{u}}{C {I}_{u}} \vert \qquad ( 25 )$$
where CIᵤ denotes the characteristic indicators of the original load demand curve; RCIᵤ represents the characteristic indicators of the reconstructed load demand curve; wᵤ indicates the weighting coefficient of the characteristic indicators; DR signifies the discrepancy between the characteristic indicators of the reconstructed and original load demand curves;
$$C {I}_{1} = {L}_{a v e} \qquad ( 26 )$$
$$C {I}_{2} = {L}_{a v e} / {L}_{max}$$
$$C {I}_{3} = ( {L}_{max} - {L}_{min} ) / {L}_{max}$$
$$C {I}_{4} = {L}_{ave , peak} / {L}_{a v e}$$
$$C {I}_{5} = {L}_{ave , low} / {L}_{a v e}$$
$$C {I}_{6} = {T}_{max}$$
$$C {I}_{7} = {T}_{min}$$
where CI₁, CI₂, CI₃, CI₄, CI₅, CI₆, CI₇ represent daily average load, daily load rate, daily peak-valley difference rate, peak period load ratio, valley period load ratio, peak occurrence time, and valley occurrence time of the original load curve, respectively; Lₐᵥₑ, Lₘₐₓ, Lₘᵢₙ represent the daily average, maximum, and minimum loads of the original load curve, respectively; L_{ave, peak}, L_{ave,low} represent the average loads during peak and valley periods of the original load curve, respectively; Tₘₐₓ, Tₘᵢₙ represent times of daily peak and valley load occurrences of the original load curve, respectively;
$$R C {I}_{1} = {L}_{ave}^{r e} \qquad ( 27 )$$
$$RC {I}_{2} = {L}_{ave}^{r e} / {L}_{max}^{r e}$$
$$RC {I}_{3} = ( {L}_{max}^{r e} - {L}_{min}^{r e} ) / {L}_{max}^{r e}$$
$$RC {I}_{4} = {L}_{aνe , peak}^{r e} / {L}_{ave}^{r e}$$
$$RC {I}_{5} = {L}_{aνe , low}^{r e} / {L}_{ave}^{r e}$$
$$RC {I}_{6} = {T}_{max}^{r e} = {T}_{max}$$
$$RC {I}_{7} = {T}_{min}^{r e} = {T}_{min}$$
where RCI₁, RCI₂, RCI₃, RCI₄, RCI₅, RCI₆, RCI₇ represent daily average load, daily load rate, daily peak-valley difference rate, peak period load ratio, valley period load ratio, peak occurrence time, and valley occurrence time of the reconstructed load demand curve, respectively; Lₐᵥₑ, Lₘₐₓ, Lₘᵢₙ represent the daily average, maximum, and minimum loads of the reconstructed load demand curve, respectively; L_{ave, peak}, L_{ave,low} represent the average loads during peak and valley periods of the reconstructed load demand curve, respectively; Tₘₐₓ, Tₘᵢₙ represent times of daily peak and valley load occurrences of the reconstructed load demand curve, respectively;
$${L}_{t}^{r e} = {L}_{low}^{r e} ( t ∈ {φ}_{1} ) \qquad ( 28 )$$
$${L}_{t}^{r e} = {L}_{flat}^{re} ( t ∈ {φ}_{2} )$$
$${L}_{t}^{r e} = {L}_{p e a k}^{r e} ( t ∈ {φ}_{3} )$$
where
$${L}_{low}^{r e} , {L}_{flat}^{r e} , {L}_{peak}^{re}$$
denotes the values of the reconstructed load curve during valley, flat, and peak periods, respectively;
Step 4: Construct a uniform step-size search method using the Python-Numpy computational package to solve the load reconstruction model in Step 3, as detailed below:
Step 4.1 identify the maximum load Lₘₐₓ and minimum load Lₘᵢₙ from the load sequence; determine the search step size sw, and generate an equidistant search set {r₁, r₂, . . . , rₐ, . . . , r_{A}}, where rₐ=Lₘᵢₙ+sw*(a−1); a represents the element index in the search set; A denotes the total number of elements in the set;
Step 4.2 define b₁, b₂, b₃ as sequential indices of elements in the search set; initialize b₁=1, b₂=b₁+1, b₃=b₂+1, and set
$${L}_{l o w}^{r e} = {r}_{{b}_{1}} , {L}_{flat}^{re} = {r}_{{b}_{2}} , {L}_{peak}^{r e} = {r}_{{b}_{3}} ;$$
generate the corresponding reconstructed load curve, compute the load characteristic indicators, and evaluate the objective discrepancy rate DR_{b}_{₁}_{,b}_{₂}_{,b}_{₃}. Set DR=DR_{b}_{₁}_{,b}_{₂}_{,b}_{₃};
Step 4.3 perform incremental operations on variables b₁, b₂, b₃ until b₁=A−2, b₂=A−1; calculate the corresponding objective function value DR_{b}_{₁}_{,b}_{₂}_{,b}_{₃}; if DR<DR_{b}_{₁}_{,b}_{₂}_{,b}_{₃}, update DR_{b}_{₁}_{,b}_{₂}_{,b}_{₃} to identify the reconstructed load curve corresponding to the optimal objective function value;
Step 4.4 determine the optimal objective function value DR and its corresponding reconstructed load curve through the optimization process;
Step 5: construct a short- and medium-term nested scheduling model for basin-wide hydro-wind-solar systems, accounting for left/right bank interdependencies and upstream-downstream hydraulic coupling in cascade hydropower stations, while integrating medium- and short-term dispatch constraints;
the objective function for maximizing power generation is as follows:
$$max E = {\sum }_{n = 1}^{N} {\sum }_{j = 1}^{2} {\sum }_{d = 1}^{D} {P}_{n , j , d} Δ t \qquad ( 29 )$$
$${P}_{n , j , d} = {P}_{n , j , d}^{hydro} + {P}_{n , j , d}^{wind} + {P}_{n , j , d}^{s o l a r}$$
where E is the objective function of maximum power generation, MWh,
$${P}_{n , j , d}^{hydro}$$
it the output of hydropower plant j at station n on day d, MW;
$${P}_{n , j , d}^{w i n d} , {P}_{n , j , d}^{solar}$$
are the outputs of wind and solar plants bundled with hydropower plant j at station n on day d, respectively, MW; P_{n,j,d} is total bundled output (hydro-wind-solar) from plant j at station n on day d, MW; Δt is daily duration in hours, h; n, N are index and total number of hydropower stations; j is the plant index (j=1: left-bank plant; j=2: right-bank plant). d and D are day index and total dispatch horizon, respectively;
the objective function for minimizing power transmission deviation is as follows:
$$min ED = {\sum }_{s = 1}^{S} {\sum }_{n = 1}^{N} {\sum }_{j = 1}^{2} {\sum }_{d = 1}^{D} {\sum }_{t = 1}^{T} {( {P}_{s , n , j , d , t}^{t r a n s} - {η}_{s , n , j , d} {ξ}_{s} ( t ) )}^{2} \qquad ( 30 )$$
where ED is the objective function quantifying power transmission deviation, MW²;
$${P}_{s , n , j , d , t}^{t r a n s}$$
is the scheduled transmission power from plant j at station n to province s at time t on day d, MW; ξₛ(t) is the load demand of province s, represented by the reconstructed load curve from Step 4; η_{s,n,j,d} is the scaling factor for load demand at receiving-end province s; s, S are province index and total number of provinces; t and T are time interval index and total number of intervals, respectively;
in addition to conventional constraints, the model incorporates nested medium- and short-term energy balance constraints, where the daily energy output derived from medium-term dispatch must equal the sum of intraday generation across all time intervals, as specified in Eq. (31);
$${P}_{n , j , d}^{hydro} = {\sum }_{t = 1}^{T} {P}_{n , j , d , t}^{hydro} / T \qquad ( 31 )$$
$${P}_{n , j , d}^{wind} = {\sum }_{t = 1}^{T} {P}_{n , j , d , t}^{wind} / T$$
$${P}_{n , j , d}^{solar} = {\sum }_{t = 1}^{T} {P}_{n , j , d , t}^{solar} / T$$
$${P}_{s , n , j , d}^{trans} = {\sum }_{t = 1}^{T} {P}_{s , n , j , d , t}^{hydro} / T$$
Step 6: on the Gurobi solver platform, implement computationally efficient optimization by converting the medium-term dispatch method for basin-wide hydro-wind-solar systems into a mixed-integer linear programming (MILP) formulation via Python programming; the specific steps are as follows;
Step 6.1 the multi-objective optimization model incorporating both power generation maximization and power transmission deviation minimization is converted into a single-objective formulation using the constraint transformation method; This is achieved by reconfiguring the power generation maximization objective as a constraint under the deviation minimization objective, as detailed in Eq. (32);
$$min ED = {\sum }_{s = 1}^{S} {\sum }_{n = 1}^{N} {\sum }_{j = 1}^{2} {\sum }_{d = 1}^{D} {\sum }_{t = 1}^{T} {( {P}_{s , n , j , d , t}^{t r a n s} - {η}_{s , n , j , d} {ξ}_{s} ( t ) )}^{2} \qquad ( 32 )$$
$$s . t . E \geq {E}^{set}$$
where E^{set} denotes the total generation requirement of the basin-wide hydro-wind-solar system during the dispatch period, MWh; initial value of E^{set} is defined as the maximum generation capacity when power transmission deviation objectives are excluded, which corresponds to the optimal objective function value of the daily generation maximization model;
Step 6.2 for the univariate nonlinear relationship between water level and reservoir storage, apply piecewise linearization for processing; for the bivariate nonlinear relationship in hydropower generation functions, implement linearization using a two-dimensional linear interpolation method based on parallelogram partitioning;
Step 6.3 a set of non-dominated solutions (Pareto front) for the multi-objective optimization model is generated by iteratively relaxing generation capacity constraints;
Step 6.4 calculate the comprehensive benefit index to select the optimal dispatch plan from the solution set, with the index formulation defined in Eq. (33);
$$F = \frac{E - {E}_{min}}{{E}_{max} - {E}_{min}} + \frac{E {D}_{max} - E D}{E {D}_{max} - E {D}_{min}} . \qquad ( 33 )$$
